(19) United States
(12) Patent Application Publication
(10) Pub. No.: US 2007/0091069 A1
(43) Pub. Date: Apr. 26, 2007

(54) Mini ball displacement detecting system

(76) Inventor: Ying Jay Yang, Taipei (TW)

Correspondence Address: BACON & THOMAS, PLLC, 625 SLATERS LANE, FOURTH FLOOR, ALEXANDRIA, VA, 22314, US

(21) Appl. No.: 11/519,021

(22) Filed: Sep. 12, 2006

(30) Foreign Application Priority Data
Oct. 21, 2005 (TW) 094136944

(51) Int. Cl. G09G 5/08

(52) U.S. Cl. 345/167

(57) ABSTRACT

The present invention relates to a mini ball displacement detecting system consisting of a laser diode as a light source; a ball rotationally supported by a ball cage and having a portion projecting outside the cage; and a photo-detector consisting of a sensor component and an analysis component. Rolling the ball will create laser interference images from the laser light emitted by the laser diode, which can be detected by the photo-detector after the laser light reflects off the surface of the ball. The analysis component then analyzes the interference images to determine the displacement of the surface of the ball relative to the system, generating a digital signal useable to move a cursor on a display screen. The ball can have a diameter of less than 15 mm and thus the present invention can be applicable to a variety of compact, slim, and lightweight portable electronic products.

### BACKGROUND OF THE INVENTION

1. Field of the Invention

The present invention relates to a displacement detecting system and more particularly to a mini ball displacement detecting system.

2. Related Art

The most common pointing device used with personal computers is the mouse. A mouse may be further classified as a ball mouse or an optical mouse.

The prior art ball mouse has a ball mounted on its underside, allowing the ball to roll over a reference surface (e.g., desktop) as the mouse is moved. As the ball rotates it turns a pair of shaft encoders positioned along the x and y coordinates, which in turn rotates each shaft encoders' corresponding encoding wheel. Rotation of the encoding wheel between a light source and a photodetector causes a series of light pulses to be received by the photodetector. By configuring as such, the rotation of the ball along the X and/or Y directions can be interpreted as cursor movements on a computer screen.

Another prior art, the trackball mouse, has its ball mounted on its top surface. Similarly, by rolling the trackball with the fingers along the X and/or Y directions, digital signals can be created to control the cursor on a computer screen.

But both are unsatisfactory for the purpose for which the invention is concerned for the following reasons: its sensitivity is low. Typically, a ball mouse has a resolution in the range of 100 to 200 dpi (dots per inch). Thus, a user has to roll the ball a relatively long distance in order to move the cursor on the computer screen. Further, to allow for this longer rolling distance, a trackball typically requires a diameter of around 20 to 30 mm to be easily useable. In light of the continuing technological trend towards miniaturization, the bulky profile of the current trackballs is no longer feasible.

As shown in FIG. 1, a typical optical mouse 1 uses an LED 11 to emit light 11, which is reflected through a reflector 12 onto a reference surface 15 (e.g., desktop), which it reflects off of as light 12 to create an image of varying brightness. This image then passes through a lens 13 to form an image focused on a photodetector 14. The photo-detector 14 then analyzes and compares the sequential images captured to determine the direction and distance of the optical mouse displacement. This information then generates a digital signal useable to move the cursor on a computer screen. The typical optical mouse 1 has a resolution of about 400 to 800 dpi higher than the typical ball mouse. That is why the ball mouse has gradually been replaced by the optical mouse.

However, the LED used in the optical mouse may consume much power (e.g., about 30 to 50 mA during continuous operation). The LED consumes one third to about one half of the optical mouse's total operational power. Also, because of the diffuse nature of LED light, its resolution is limited to 800 dpi at most. Thus, its sensitivity is still low and unacceptable for future technological demands.

As portable electronic products such as notebook computers, mobile phones, personal digital assistants (PDAs), and MP3 (MPEG, player 3) player etc. become slimmer, lighter, and more functionally integrated, future products such as mobile phones may be equipped with desktop management and internet browsing capabilities. However, the currently available pointing devices are too large to be incorporated in such portable electronics, and hinder the development of smaller, more compact devices.

Concerning the aforementioned issue, the structure and components of the optical mouse were extensively researched in an attempt to achieve a mouse design with greater sensitivity, lower power consumption, and a smaller profile, thus leading to the development of the present invention.

### SUMMARY OF THE INVENTION

It is therefore an object of the present invention to provide a mini ball displacement detecting system having the advantages of high resolution, lower power consumption, and a small profile.

To achieve the above and other objectives, the present invention provides a displacement detecting system consisting of a laser diode as the light source; a trackball to control and provide displacement information to the system; and a photodetector that consists of a sensor component and an analysis component. Whereby the sensor component will detect the interference image created by the laser light reflected off the ball's surface, and the sequential interference images captured will then be analyzed and compared by the analysis component to determine the displacement of the ball relative to the system. This information can then be used to generate a digital signal to control the cursor on a computer screen.

Using laser diodes as the light source for the displacement detecting system, the speckles created from the laser interference patterns, are very small and can be described by the following equation:
δ=1.2λL/D
where δ is the diameter of the speckle, λ is the wavelength of the laser light, L is the distance from the laser illuminated ball surface to the photodetector, and D is the diameter of the laser illuminated spot on the ball surface. For instance, when using laser with wavelength λ of 0.85 μm, L of 10 mm, and D of 2 mm, the laser interference speckle diameter 6 is about 5 μm. Also, the resolution can be expressed as the reciprocal of twice the diameter of the speckle or ½δ and can reach around 2500 dpi. The resolution can be further increased to about 3500 dpi due to amplification by the curvature of the mini ball. This resolution of 3500 dpi is about 20 times of that of the prior art ball mouse or about 5 times of that of the prior art optical mouse.

Consequently, the mini ball of the present invention may have a diameter of less than 15 mm or even less than 5 mm. Thus, the invention is applicable to a wide variety of compact, slim high-technology products (e.g., notebook computers, mobile phones, PDAs, MP3 players etc.)

The photodetector of the present invention may be a complementary metal-oxide semiconductor (CMOS), phototransistor, or charge-coupled device (CCD). Because these devices are well known in the art, a detailed description thereof is thus deemed unnecessary.

The laser diode and the photodetector in the mini ball displacement detecting system of the present invention may be assembled as a single-unit member of assembled separately. Further, the laser diode may be implemented as a vertical-cavity surface-emitting laser (VCSEL), which is advantageous because of its relatively lower operational power consumption. Thus, VCSEL is particularly applicable to battery-operated portable electronic products.

### BRIEF DESCRIPTION OF THE FIGURES

The above and other components, features and advantages of the present invention will become apparent from the following detailed description along with the accompanying figures.

FIG. 1 is a block diagram schematically depicting a light path in a conventional optical mouse.

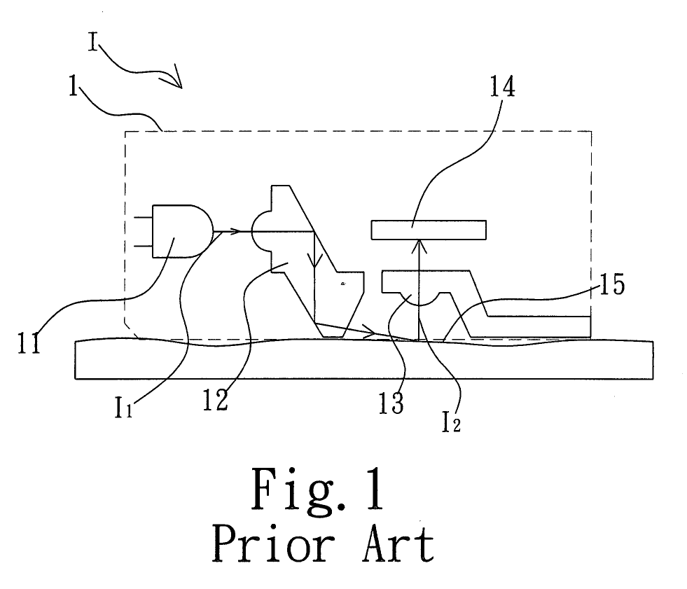

FIG. 2 is a block diagram schematically depicting light paths in a mini ball displacement detecting system of the present invention.

### DETAIL DESCRIPTION OF THE INVENTION

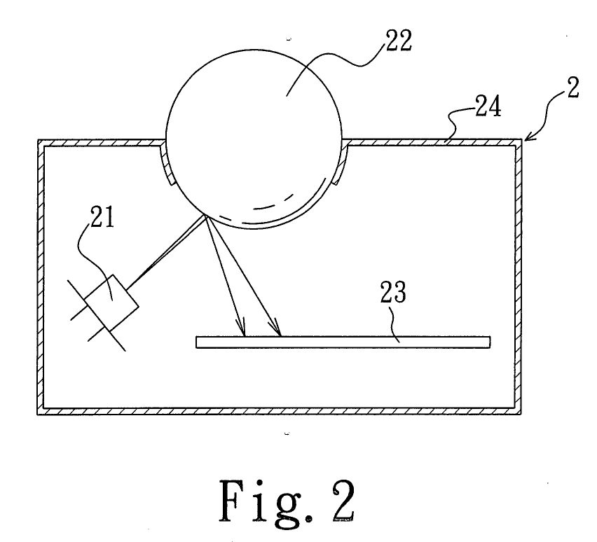

The present invention, the mini ball displacement detection system 2, is as shown in FIG. 2, which includes a laser diode 21, a small ball 22, and a sensor system 23. Of which, the motion of the ball 22 can be used to control a cursor's motion on the screen; the sensor system 23 includes a sensor component as well as an analysis component (not displayed in figure); and using light emitted from the laser diode and reflected off the surface of the ball to the sensor component, the sensor detects the interference image created by laser reflecting off a surface, and the analysis component determines the displacement of the ball relative to the displacement detection system.

In the present invention, the ball 22 is enclosed in a cage 24, with a portion of the ball 22 projecting from the cage. Through this projection, the ball's motion can be controlled by rolling it with the fingers. Depending on the motion of the ball's surface, as the laser light from the laser diode 21 reflects off the ball's surface, interference images are created. These interference images are detected by the sensor system 23 and analyzed to determine the displacement of the ball's surface to create digital signals to guide the cursor on the computer screen.

With the present invention, because the using of laser instead of LED, its resolution can exceed 3500 dpi. Using the present invention, if applied to a mini-ball displacement detection system, a ball of even 5 mm can be used to easily control the cursor on the screen, which contributes to minimize the size and thickness of the displacement detection system. In addition, because laser diodes require less energy to operate than LED's, the present invention can operate under lower power consumption levels as compared to the LED counterparts. Its low power consumption quality allows it to be applicable to various compact portable electronic products, such as notebook computers, PDA's, mobile phones etc. as well as future, more integrated electronic products, and thus facilitates the development of smaller, slimmer electronic equipment.

While the invention herein disclosed has been described by means of specific embodiments, this by no means limits the scope of the present invention. As long the numerous modifications and variations that can be made thereto by those skilled in the art do not depart from the scope and spirit of the invention set forth in the claims, they still remain within the scope of the present invention.

What is claimed is:

1. A mini ball displacement detecting system, which includes:
a trackball, used to control the displacement detecting system;
a laser diode to emit laser light onto the surface of the trackball;
a photo-detector that consists of a sensor and an analysis unit, of which the sensor component received the interference image reflected off the surface of the ball, while the analysis component analyzes and compares the various interference images that differ depending on the magnitude and direction of the ball's motion to determine the displacement of the ball's surface relative to the system.

2. The mini ball displacement detecting system of claim 1, wherein the laser diode is a vertical cavity surface-emitting laser (VCSEL).

3. The mini ball displacement detecting system of claim 1, wherein the trackball has a diameter of less than 15 mm.

4. The mini ball displacement detecting system of claim 1, wherein the photodetector is one of a CMOS, a phototransistor, and a CCD.

5. The mini ball displacement detecting system of claim 1, wherein the laser diode and the photodetector are formed as a single-unit member, in which the photodetector is one of a CMOS, a phototransistor, or a CCD.

6. The mini ball displacement detecting system of claim 1, which consists of a ball cage for rotationally supporting the ball with a portion of the ball projecting from the ball cage.
